(19) United States
(12) Patent Application Publication
(10) Pub. No.: US 2009/0081091 A1
(43) Pub. Date: Mar. 26, 2009

(54) ROTARY BEARING SUPPORT

(75) Inventor: Olaf L. Lee, St. Paul, MN (US)

Correspondence Address: MERCHANT & GOULD PC, P.O. BOX 2903, MINNEAPOLIS, MN, 55402-0903, US

(73) Assignee: ALLIANCE TECHNOLOGY GROUP, INC., Roseville, MN (US)

(21) Appl. No.: 11/663,484

(22) PCT Filed: Sep. 21, 2004
(86) PCT No.: PCT/US2004/030961

§ 371 Date: Jul. 23, 2008

(51) Int. Cl. B01J 19/00

(52) U.S. Cl. 422/307

(57) ABSTRACT

An apparatus and method, for processing solid waste to produce a solid fuel product and a recycling stream, involves an elongated, generally cylindrical shape rotating pressure vessel that can use the effects of heat, humidity and pressure to convert the solid waste into a burnable fuel and can produce a glass, a metal or a plastic recycle stream. The pressure vessel is adapted to be rotated along its axis or rotation in order to ensure close contact between the solid waste and internal humidity at elevated temperatures and pressures to result in the conversion of the solid waste into a useful fuel and recycle stream. The driving mechanism and support structure for the vessel requires substantial strength and resistance to wear. The pressure vessel of the invention, while requiring rotation around its axis of rotation, also requires the pressure vessel to be movable in the vertical plane. Accordingly, the pressure vessel rotates on its axis of rotation and moves through an are in the vertical plane for charging, processing and discharge. The support structure for the vessel must both support the weight of the vessel and cause the vessel to rotate along its axis of rotation. The support system maintains the pressure vessel in a useful position throughout its axis of rotation and through its angle of orientation. The invention involves a support structure and drive mechanism that can actuate the rotational and arcuate movement.

This application is being filed as a PCT International application in the name of Alliance Technology Group, Inc., a U.S. corporation, on 21 Sep. 2004.

### FIELD OF THE INVENTION

The invention relates to a pressure vessel used to recycle solid waste and produce usable fuel with recycle streams. The vessel treats recycled solid waste by contacting the solid waste with high temperature, pressure and humidity in a treatment vessel that rotates along a longitudinal axis. The vessel is supported by a frame and bearing that supports the load of the vessel and permits the vessel to rotate freely at varying rpm's depending on the process step and conditions of the process. The bearing has an extended useful life, is easy to maintain and requires minimum attention during use.

### BACKGROUND OF THE INVENTION

The disposal of solid waste materials has become a major problem for both public and private organizations. Recycling programs have successfully used a portion of this waste stream, however, the vast majority of waste streams are either burned or introduced into landfills.

Throughout the built environment, the amount of solid waste generated by the individual households, businesses and governmental units has substantially increased over the last ten years. Disposal of such waste materials has become an increasingly difficult problem for both private and public organizations. The convenience and cost of waste disposal has steadily increased along with the environmental impact of the solid waste on land use, potable water and the atmosphere.

Recycling efforts have had some success, however, the major proportion of recyclable materials is discarded as solid waste and requires removal from solid waste streams for recycling purposes. In order to obtain valuable materials, solid waste materials have been treated or pretreated. None of these pretreatment processes have been widely accepted in view of the relatively high cost and low efficiency of solid waste separation processes. One attempt to introduce apparatus systems and processes for treating waste material to form a useful fuel and a glass, a metal or other recyclable streams is found in Anderson, U.S. Pat. Nos. 5,445,329, 5,540,391, 5,655,718 and the related PCT WO 95/13148 and also in Garrison et al., PCT WO 00/72987. These patent references disclose apparatus, methods and processing of municipal solid wastes into fuel and recyclable streams such as a glass stream, a metal stream and a plastic stream if implemented.

These processes involve an apparatus that can be used to treat solid waste material. The waste material is placed into a vessel, contacted with steam and processed at high temperature and pressure. The moisture, temperature and pressure within the vessel contacting the solid waste under conditions of rotary agitation can cause the solid waste product to break down into a useful burnable solid fuel and can also result in a separable metal, glass and plastic stream that can be readily removed from the solid fuel material using conventional separation techniques based on magnets, density and other particle-size type separating systems such as a trammel or flat bed separator. The vessel used to treat the solid waste requires the application of at least some pressure to successfully treat the solid waste efficiently. The pressure, up to as high as 600 psi (about 4137 kPa), but often about 60 psi (about 413.7 kPa) or as low as 15 psi (about 103.4 kPa), is maintained within the vessel between charging and discharging the vessel using a closure system. The prior art apparatus and processes, while adequately treating the solid waste for the purpose of obtaining fuel and separable recyclable stream can have its productivity reduced by the difficulty in attaching the closure after charging and then removing the closure from the vessel for the purpose of discharging the treated waste.

A variety of prior art pressure vessel closure systems have been disclosed in the art. Such systems are shown in, for example, Carpenter, U.S. Pat. No. 5,142,830, shows a rotary bearing support most easily seen in FIGS. 5 and 6 and described in Column 2, lines 44 through 54. Cametti et al., U.S. Pat. No. 4,622,860, relates to a power mining shovel support for a rotatable shovel mount. The bearing support is primarily shown in FIG. 4 and described at Column 5, lines 63 through 69. Nollet, U.S. Pat. No. 4,178,232, shows a solids separating apparatus somewhat related to the present invention in FIG. 1 and the support members 22 and 24 that are driven by the motor 16 and supported on support member 15. These structures are discussed at Column 5, lines 4 through 19. Kelman, U.S. Pat. No. 4,115,695, shows a rotatable X-ray type tomography machine having supports shown in FIG. 7 using a bearing in V-shaped grooves that supports the rotation of the X-ray device structure. Huszar, U.S. Pat. No. 2,518,143, shows, primarily in FIG. 3, bearing members that support the vessel in a vertical mode. These structures are discussed at Column 3, lines 9 through 32. Placzek, U.S. Pat. No. 4,974,781, shows in the figures as rail support roller 58 and discharge door 60, aspects of a pressure vessel. Anderson, U.S. Pat. Nos. 5,445,329, 5,540,391 and 5,655,718 show supports 62, 64. The patents disclose that the pressure vessel of the patents rotates on the rollers shown in the figures. Koenig, U.S. Pat. Nos. 6,588,690 and 6,752,337 show a discharge closure for a pressure vessel in FIGS. 1 and 10, closure 70-72 and rollers 108. A number of other patents generally disclose wheel driven and supported pressure vessels including Holloway, U.S. Pat. No. 5,361,994; Keller et al., U.S. Pat. No. 5,134,944; Taricco, U.S. Pat. No. 5,666,878; Malley, U.S. Pat. No. 6,397,492 and Bouchette et al., U.S. Pat. No. 6,458,240.

In light of the patented technology disclosed above, a substantial need exists for a pressure vessel system that is capable of maintaining a pressure vessel at a high internal pressure greater than about 206,850 Pa (206.85 kPa), at a high internal temperature of about 140° C., additionally at a substantial relative humidity, i.e., greater than about 100% relative humidity. The closure must be rapidly and easily moved from an open to a closed position. The rapidity of movement during discharge and introduction of solid waste operation enhances efficiency and cost control. The rate at which the closure can be opened and closed can substantially increase productivity, reduce costs and improve the overall quality of the solid waste or recycled streams.

In light of the need for development of new support and drive systems, a substantial need exists to reduce the wear in the support system and to increase the rapidity of maintenance and replacement of drive systems when maintenance is required.

### SUMMARY OF THE INVENTION

Applicants have found an improved support system and drive mechanism for a large rotatable pressure vessel that can maintain high heat, pressure and humidity within the vessel. The time and temperature of the process is adapted to maintaining the thermoplastic materials intact and cannot cause the melt coating of the internal surfaces vessel with a melt plastic. The elongated generally cylindrical pressure vessel can be supported at one end by a drive mechanism. At the opposite end, the pressure vessel is supported in a frame containing a bearing. The bearing is configured to support the pressure vessel in an axial load and a thrust load orientation. The direction of these orientations will change depending on the angle of the pressure vessel, prior to, during, and after use. The pressure vessel has a collar member at the end of the pressure vessel that rests in contact with the bearing, supporting the thrust load and a different portion of the collar in contact with the bearing that supports the axial load.

### BRIEF DISCUSSION OF THE DRAWINGS

FIG. 1 is an isometric view of the pressure vessel of the invention showing the drive mechanism, door and support frame.

FIGS. 2A and 2B are views of the frame and plate support for the vessel of FIG. 1 including an array of attachment apertures in the plate for attachment of the bearing mechanism.

FIGS. 3A through 3C are detailed views of the support end of the pressure vessel showing a pressure vessel flange that can be used for attachment to the bearing structure.

FIG. 4A is a cross sectional view of the bearing structure used to mount the pressure vessel within the plate and frame shown in FIGS. 1 and 2. FIGS. 4B and 4C are views of an array of fastener apertures placed in the bearing structure that match with the aperture structures shown in FIGS. 2A and 3C. These aperture arrays permit attachment of the vessel to the bearing in FIG. 4A and attachment of the bearing to the frame and plate of FIGS. 1 and 2.

### DETAILED DISCUSSION OF THE DRAWINGS

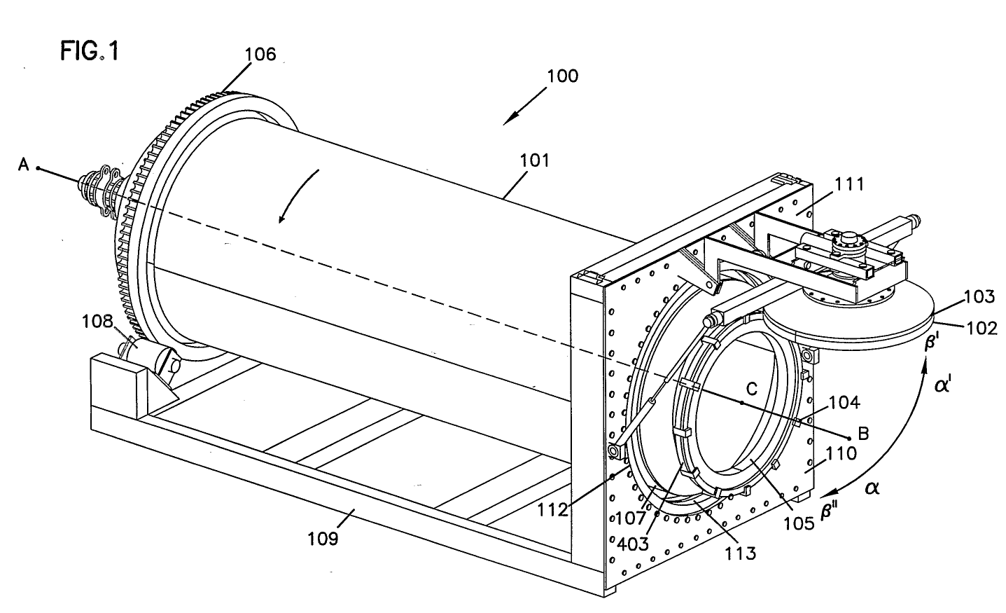

FIG. 1 is an isometric view of the pressure vessel of the invention mounted using a frame and bearing member with a rotary gear driven mechanism. The bearing structure or race is about 2.5 to 3.5 meters in diameter. Not shown in FIG. 1 is a mechanism that can cause the vessel opening to be raised to a loading position and lowered to a discharge position. Such equipment is known in the art and can consist of a cantilevered hydraulically driven lift. In FIG. 1 is a line ACB positioned at the axis of the rotation of the vessel. The direction of rotation of the vessel is shown represented by an arrow in FIG. 1, but can be in either direction at the choice of the operating personnel. The line segment ACB has a point C that is proximate the opening of the vessel. As the vessel is moved, the line ACB can be raised or lowered about point A such that the point B is raised to position β′ through angle α′ into a position at which the vessel can be charged with solid waste. After processing, the vessel is placed in a position such that point B is at position β″ and is lowered by angle α to a discharge position such that the treated solid waste can be discharged from the vessel. Conventional electric, hydraulic or mechanical means can be used to raise and lower the angle of the rotating vessel. As can be seen in the drawing, ease of movement and repetition of opening and closing of the door can be an important aspect of obtaining a quick and efficient charge of the solid waste into the vessel accompanied with a quick and efficient discharge of treated waste at the end of the processing.

FIG. 1 shows the overall vessel assembly 100, including pressure vessel 101, gear drive 106, 108 and support structure 110. The pressure vessel 101 is shown with its indicated direction of rotation. Pressure vessel 101 is supported at a drive end by a geared support system including and a drive motor 108 and gear drive 106. At the opposite support end of the vessel, is a support end comprising frame 109, plate 111 and bearing assembly 113. At the support end of the vessel 101 is a vessel support frame and bearing assembly 113 that supports the thrust load (30,000 kg to 10,000 kg) of the pressure vessel and the axial load (30,000 to 100,000 kg) or weight load of the pressure vessel in its various operating orientations. The assembly comprises a plate 111, and installed in a circular aperture 112, a bearing assembly 113 that support the vessel. When in its depressed mode, the thrust load of the pressure vessel against the support frame is substantial, while in its elevated mode for charging, the thrust load of the pressure vessel against the support frame is reduced. However, the axial or weight load of the pressure vessel on the support frame is relatively constant regardless of orientation.

The support vessel rotates about line ACB at a rate of about −8 to 8 revolutions per minute in order to adequately treat the solid waste for form an easily separable fuel component from a recycle stream that comprises metal, plastic and glass which can be subsequently separated into separate glass, metal and plastic streams in downstream processing (not shown).

Vessel 101 has an opening that provides access to the interior of vessel 101. FIG. 1 further shows door 102, which covers the opening, and door vessel closure surface 105. As the door closes, surface 102 contacts surface 105 to create a metal to metal seal. Door 102 further has a split ring, ring keeper or locking ring 103 which expands or contracts to lock or unlock and open the door. The vessel opening further comprises a vessel locking member 104 that interacts with the locking ring to lock the door in a closed position. Member 104 is positioned with a recess having a position into which the locking keeper or locking ring 103 can expand and lock the door 102 in place. Door 102 is shown in FIG. 1 in an open position. In a closed position, the door is placed such that surface 102 contacts surface 105 in a closed and sealed position.

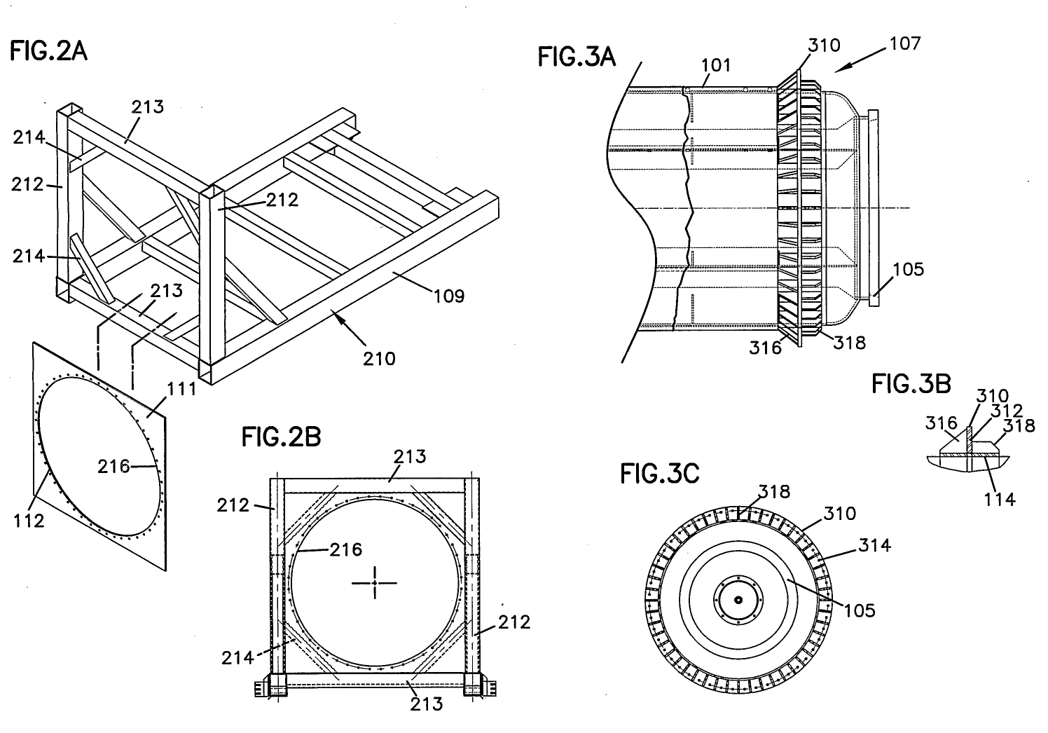

FIGS. 2A and 2B provide details regarding frame support structure to which the bearing is assembled. In FIG. 2A is shown frame 109. Frame 109 comprises horizontal support members 210, vertical support members 212, horizontal plate support members 213 and diagonal plate support members 214, which extend from vertical members 212 to horizontal plate members 213. These support members are assembled into a support structure and vertical frame support structure for the bearing. Plate 111 is installed into the frame defined by vertical support members 212, horizontal support members 213 and diagonal support members 214 using conventional attachment means including welding. Plate 111 includes a circular aperture 112 into which the bearing assembly is installed and attached to plate 111. Plate 111 includes an array of fastener apertures 216 around the perimeter of aperture 112 through which conventional fasteners can be placed into the bearing support. Such fasteners (not shown) can include bolts secured with nuts or other known fasteners of appropriate size and grade. These fasteners attach the bearing assembly to plate 111.

Frame 109 is movable through an arc to ensure that vessel 101 can be placed in the appropriate orientation (see FIG. 1, angle α and α′) for charging of the vessel with solid waste and to be placed in another appropriate orientation for the removal of the treated waste into a fuel fraction, and a glass, plastic and metal fraction, depending on the nature of the solid waste input.

FIGS. 3A and 3B show details of support end 107 of vessel 101, which has the door contact surface 105. Support end 107 extends through aperture 112 and is retained by plate 111, as illustrated in FIG. 1. The vessel support end 107 includes a bearing flange assembly 310 present on surface 114 of vessel 101. Bearing flange assembly 310 comprises a bearing attachment flange 312 (see FIG. 3B) that extends perpendicular from the vessel surface 114. Attachment flange 312 is longitudinally reinforced by proximal flange supports 316 and distal flange supports 318, their positions being referenced from the door seal 105.

Bearing flange assembly 310, particularly attachment flange 312, is attached plate 111 via the array of bearing fastener apertures 314, which correspond to fastening apertures 216 positioned around aperture 112 in plate 111. Typically, fasteners such as bolts are used to attach attachment flange 312 to plate 111.

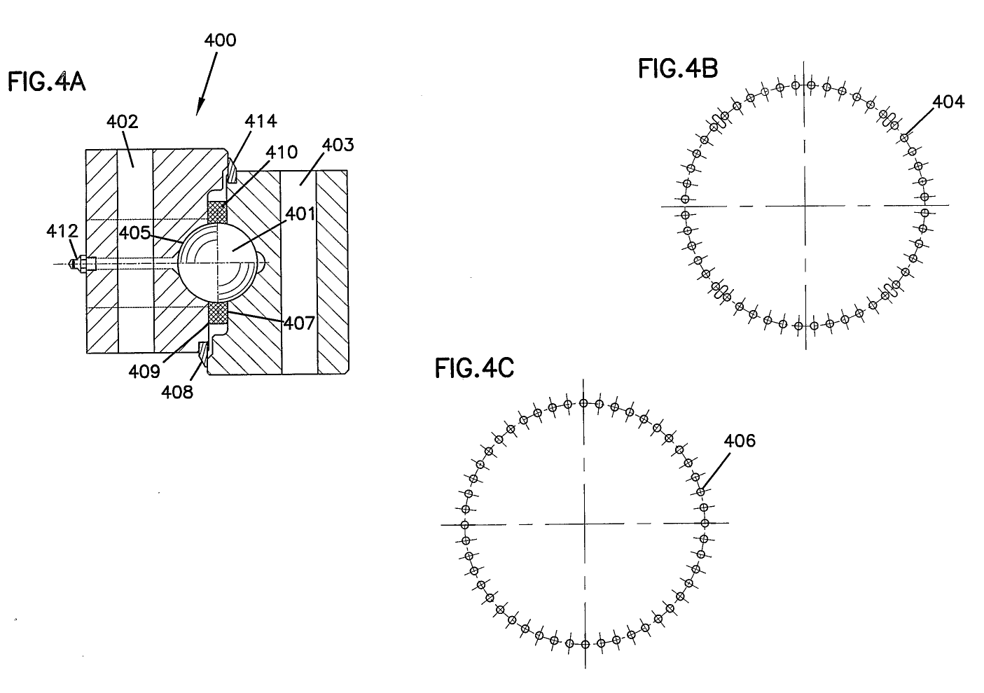

FIG. 3C is an end view of support end 107 of FIG. 3A showing the bearing assembly 310 surrounding vessel 101. Distal flanges 318 and fastener apertures 314 are illustrated positioned in an array surrounding the door contact surface 105. The array of fastener apertures 314 matches the array shown in FIG. 4C. These matched apertures permit the easy attachment of the flange assembly 310 to the bearing 400.

FIG. 4A is an enlarged cross section of the bearing structure present between the plate 111 and the bearing attachment flange 312. The bearing supports the horizontal load and the thrust load of the vessel 101 against the support structure 110 and plate 111. When the vessel 101 turns as shown in FIG. 1, the bearing structure provides a substantially reduced friction rotational action between bearing 312 on vessel 101 and the surface of support structure 110 and plate 111.

Referring to FIG. 4A, the bearing assembly 400 shown provides a substantially reduced friction rotational action as frame bearing surface 405 remains stationary with support 110 and plate 111 while the vessel bearing surface 407 rotates with the vessel 101 and bearing attachment flange 312.

In bearing assembly 400, multiple bearings 401 (about 20 to 120 individual bearing units) are placed between frame bearing surface 405 and vessel bearing surface 407 in order to provide a substantially reduced friction rotational motion. Each bearing comprises a spherical steel unit 1 to 12 inches in diameter. Bearing 401 is shown placed between frame bearing surface 405 and vessel bearing surface 407. A lubricant (not shown) is introduced between the bearing surfaces 405 and 407 along with the bearing itself 401 through fitting 412. The lubricant is retained in contact with bearing 401 and surfaces 405 and 407 via seals 409 and 410. Secondary seals 408 and 414 at the periphery of the surfaces 405 and 407 further ensure the lubricant remains in contact with the bearing.

The bearing 401 is positioned in frame 210 and bearing assembly 400 by mounting the frame bearing surface 405 onto support structure 110 via outer race frame attachment 402. The frame bearing surface 405 is attached to the support structure 110 using attachment means, typically bolts and nuts, that are placed through the outer race frame attachment 402 using the outer race fastener apertures 404 (FIG. 4B) to attach the outer race frame attachment 402 to the support structure 110. The attachment apertures 404 match the array of fastener apertures 216.

Similarly, vessel bearing surface 407 is attached to bearing flange assembly 310, particularly to bearing attachment flange 312 by the inner race vessel flange attachment 403. A similar inner race frame attachment aperture array 406 (FIG. 4C) is used to attach the inner race vessel flange attachment 403 to the vessel attachment flange 312. The array of inner race fastener apertures 406 matches the attachment apertures 314 array.

### DETAILED DISCUSSION OF THE INVENTION

The invention involves an apparatus that can be used to treat waste materials of many different types including municipal waste, industrial waste, military and governmental waste streams. Such waste streams can arise from municipal waste collection from businesses and residential locations. Such waste can include both inorganic and organic components in the form of cellulosic materials, metals, plastic, glass, food waste and others. Such wastes can be derived from packaging materials that can be mixed cellulosic paperboard packaging materials, corrugated paperboard, plastic wrap, plastic bottles, steel cans, aluminum cans, plastic or packaging materials and glass bottle and container waste. Such waste can be any combination of plastic, metal and paper, etc. Material typically available in municipal waste that can be used either as a feedstock for fuel production or as a valuable recycle product include cellulosic fiber or pulp, paperboard, corrugated paperboard, newsprint, glossy magazine stock and a variety of other cellulosic board or sheet materials that can include polymers, fillers, dyes, pigments, inks, coatings and a variety of other materials. Plastics common in recycle streams include polyolefins such as polyethylene, polypropylene, polyesters such as polyethylene terephthalate, polyvinyl chloride, mixed stream plastics and other thermoplastic materials. Metal streams can include ferromagnetic metals such as iron, steel, and magnetic alloys, non-ferromagnetic metals such as aluminum and other such materials in the form of cans, foils, sheet materials, etc. Glass materials can be clear or colored green or brown.

Once treated by the apparatus and process disclosed herein, the waste streams can produce a valuable fuel and separable metal, plastic and glass streams that can be sorted, segregated and stored using various physical parameters of the waste stream material. The ferromagnetic metals can be separated by magnetic properties; other products can be separated by density or other known parameter.

Using the pressure vessel of the invention, many contaminating components of such waste streams can be removed by the action of heat and humidity. In other words, the solid waste stream can be cleaned of contaminants improving the quality and value of the recycled products. Food waste is a common contaminant. Other contaminants are volatile materials which are quickly removed. Some materials with substantial heating value, such as inks, coatings, oils, lubricant and natural greases, and others can remain in the fuel stream. Other less valuable materials can be removed from the waste stream by solubilization using heat, humidity, mechanical process, and energy. Such contaminants can be removed from the waste stream, thus increasing the value of the product. As a result, a clean, value enhanced stream of cellulosic material, glass material, metal material and plastic material can be derived. The process implemented within the vessel of the invention uses the effects of heat, pressure and humidity within a rotating vessel to receive and process the solid waste material. The vessel is provided with an opening that can be positioned in a raised, charging position during introduction of material into the vessel. The vessel can then be operated either in the raised or horizontal position to treat the waste. When the process is ended, the vessel can be lowered to a lowered, discharge angle to remove the treated contents of the vessel and to move the contents to further processing stations.

Within the vessel, at appropriate conditions of temperature, pressure and humidity, and the rotating mechanical action of the vessel, in combination with the internal structure of the vessel, import shear forces and change in temperature and change in pressure forces on the internal structure of the waste. Such agitation and changing conditions within the vessel causes the solid waste within the vessel to expand and force fibrous materials to break fiber-to-fiber bonding, thus resulting in the production of substantially increased fibrous character in the particular cellulosic waste stream. The change in pressure and change in temperature causes substantial changes in the nature of water within the fibrous material. The change of water from a liquid to a steam improves the quality of the fibrous material resulting in a fiber that can be recycled and resulting in a pulp, fiber or high quality fuel.

The waste stream is treated through the effects of heat, humidity and pressure within a longitudinal vessel that can rotate along an axis. The longitudinal vessel has an opening at an end and a support and rotational drive means at the opposite end of the vessel. The opening in the vessel permits the waste stream to be introduced into the interior of the vessel and removed from the vessel through a door that can be readily moved from a closed position to an open position. The door is mounted on the vessel with a hinge structure and a closure system that can be rapidly implemented to either close and lock the door for processing purposes or unlock and open the door quickly for charging the waste or discharging of the treated waste.

Important aspects of the vessel involve means for introducing steam at various pressure and temperature characteristics into the interior of the vessel to heat and impart moisture or humidity to the waste within the vessel for treatment purposes. The vessel additionally includes an enclosed heated stream of fluid conduit positioned appropriately within the interior of the vessel to introduce heat. The heat within the vessel is transferred from the mobile fluid into the treatment zone. The fluid flow follows a path, typically in conduit, that permits the heating of the interior of the vessel throughout the important treatment zone. The heated fluid is separated from the waste within the treatment vessel by the conduit, keeping the mobile fluid free of contamination and in a form that can act to successfully transmit heat into the interior of the structure. The vessel includes means to rotate the vessel along a longitudinal access. In order to rotate the vessel, one end of the vessel is supported by a motor driven rotation means that can comprise a belt, chain, gear driven rotation means or other motor driven apparatus that can impart a rotation to the vessel of about −8 to about 8 revolutions per minute (rpm). The vessel of the invention, at the opposite end from the rotational means is mounted in a frame and is supported on a bearing that permits the vessel to rotate within the frame at the desired rotational speed. In light of the vessel rotation, the fluid transfer conduits are preferably configured such that the heating fluid can pass into the rotation vessel through means to transport the fluid from a stationary conduit to a rotating zone.

The invention involves a process and system that can treat a waste stream through the use of high temperature, high pressure steam that includes one, two or more vessels interconnected and also connected to common steam sources and common heated fluid sources. Such ganged vessels in sets of two, three, four or more can use or reuse steam, heat and moisture by passing the materials from vessel to vessel during operations. In such a process, a vessel having a process volume can include waste material within the vessel and can be treated with steam in the interior of such a vessel. A second vessel often having similar sizing and structure can permit steam that is directed into the interior of the vessel to be introduced into the interior of subsequent vessels for operations. As such, moisture and temperature, pressure and humidity can be shared and cycled through the ganged vessels improving efficiency and output of the process involving increased productivity for the recycle stream and the fuel stream. Within each individual vessel, the process typically includes steps such as introducing a solid waste stream into the treatment interior of the vessel, raising the temperature of the interior-processing zone of the first vessel simultaneously with the introduction of steam into the vessel. In other vessels in the ganged treatment zone, the steam from the first vessel can be transferred to subsequent vessels to utilize the pressure, temperature and water content of the steam for further processing aspects.

Within the vessel, the waste treatment is maintained in a treatment environment. In such a treatment environment, the treatment process can involve the increase of heat, pressure and humidity within the vessel as the vessel rotates along a longitudinal axis. The moisture content of the waste material increases as the temperature and pressure increases. The cellulosic material, in particular, can absorb substantial quantities of water and as the pressure vessel is rotated, the cellulosic material can reach a uniform water content that is maximized in order to obtain fiber cellulosic cell breakdown resulting in an improved fibrous recycle stream. Once the cellulosic material reaches a substantial equilibrium of water content, then the temperature and pressure within the vessel is vented from the vessel, preferably to a second or third vessel in the treatment area, also reducing the moisture content of the waste material to a predetermined level by heating the treatment material with the heated fluid. The change in pressure and temperature in conjunction with the heat from the mobile heating fluid causes moisture within the cellulosic material to change in state from a liquid to a gaseous or vapor state resulting in combination and disruption of the cellulosic fiber and cell structure, improving the quality of the resulting separated fiber materials.

Within the treatment vessel, during processing, waste material is saturated with moisture using steam and increased temperature and pressure. The waste material is tumbled using the rotational aspect of the treatment vessel. Because of the changes in temperature, pressure and moisture content, the physical characteristic of the material changes during processing. Particularly, the cellulosic materials having a cell structure and fibrous character results in disrupted cells and expanded fiber and separated fiber structure. Particle size of the cellulosic material is reduced.

An additional feature of the process and as a result of the processing characteristics, the waste material including the cellulosic material is cleaned of many of the food soils and volatile organic components. The metal, glass and plastic components of the recycle stream are similarly cleaned. These cleaning and disruption characteristics of the process result in a uniform product. The resulting fiber or pulp can be recycled to paper making or used a high quality fuel. The product uniformity is obtained by obtaining a relatively consistent set of process parameters within and throughout the vessel. Accordingly, due to the steam introduction, heat flow and rotation of the materials, the temperature, pressure and moisture content of the material tends to be substantially uniform resulting in a uniform treatment of the waste stream.

As stated above, the process of the invention can involve at least two vessels but can be used with three, four or more vessels. The municipal solid waste used within the system is typically obtained from businesses, residences, the military, governmental and other common waste stream generating locations. During the process, waste material is introduced into the vessel. Surfactant materials can act as a wetting agent increasing the degree of contact between the particular cellulosic waste material portion of the waste material and the subsequent addition of steam or water content. The moisture content of the waste material is adjusted to a desired level through the introduction of steam. The steam increases temperature and pressure within the vessel initiating the treatment process. The heated liquid conveyed throughout the interior of the vessel increases the temperature in a relatively uniform rate to achieve a desired level of temperature and pressure within the interior of the vessel. During the vessel operation, the vessel is rotated when charged, whenever the vessel is maintained at an appropriate temperature and pressure or the temperature and pressure are changed in order to comminute or modify the cellulosic materials and to discharge the products. The rotation breaks down and modifies the cellulosic cells and fiber, facilitates removal of food soil and organic contaminants from the glass, plastic and metal, objects and ensures uniformity of treatment within the vessel. At an appropriate time, the vessel is vented to begin cooling and depressurization of the vessel, while at the same time, removing moisture in the form of steam or humidity from the interior of the vessel. The heated liquid within the vessel structure heats the contents of the vessel in order to remove water resulting in a reduced moisture or substantially dried material with a moisture content that ranges from about 30 to about 50 wt % in the cellulosic component. Once sufficiently dried to be efficiently removed from the vessel and used as a fuel or recycle source, the vessel is opened, positioned appropriately and emptied of the treated waste. The vessel is then placed in the appropriate position for solid waste introduction and the vessel cycle can be restarted. The steam and pressure vented from the vessel in a previous step can be recycled in a subsequent vessel.

Before loading, the vessel is typically positioned at an angle above the horizontal of approximately 35-50 degrees as shown in angle alpha of FIG. 1. The vessel door, if not open, can be opened and a loading device, typically a conveyor, can introduce a quantity of the solid waste into the interior of the vessel. If the material is to be pretreated with surfactants, water, the material can be introduced into the waste material at this point and contacted with liquid with a conventional spray equipment resulting in a uniform pretreatment. Vessels typically comprise an internal volume of about 1200 to about 3000 cubic feet (about 34 to 85 m³) and can typically contain about 12 to 36 tons (about 12,000 to 37,000 kg) of solid waste for efficient treatment. The resulting loads (thrust and axial) on the bearing can range from 5 to 40 metric tons. During charging of the vessel with solid waste, the vessel can be maintained stationary or can be rotated to distribute the waste or initiate the treatment process resulting in a uniform mass of waste material prior to the introduction of heat and humidity. The interior of the vessel contains the fluid conduits and other veins or fins in order to improve agitation and introduction of mechanical forces on to the solid waste within the vessel. The rotation of the vessel mechanically agitates the solid waste within the vessel and begins to change the nature of the solid waste.

One added advantage of the mechanical action relates to the change in the nature of the cellulosic component of the solid waste. The treated cellulosic materials are more easily separable from the glass, plastic and metal components of the solid waste. The introduction of temperature, pressure and humidity into the solid waste causes the cellulosic components of the solid waste to absorb water, and lose tensile strength and modulus rapidly. The water tends to plasticize the fibers causing the fibers to more easily move one against the other and causing the cell structures of the cellulosic materials to swell and expand due to moisture absorption. The material undergoes substantial mechanical forces in the interior of the vessel, the material interacts within the mass of the solid waste to cause mechanical action within the waste, while simultaneously the interior of the vessel structure both causes a mechanical impact forces and shear forces on the structure of the solid waste substantially changing the solid waste characteristics. This mechanical impact and shear force reduces the material such that cellulosic material regardless of its source such as wax containing multilevel corrugated paperboard or laser printer paper rapidly loses strength, is comminuted into smaller cellulosic structures in a material having separated fibers disrupted cell structure and reduced volume and increased density. After the material is charged into the vessel, the initial condition of the solid waste is about 25-50 wt % moisture at ambient temperature and pressure.

Once the solid waste is held appropriately within the vessel, the door is closed and locked. In the vessel of the invention, the diameter of the locking ring is changed such that the locking ring interacts with a portion of both the door and the vessel seal holding the door in place with sufficient mechanical integrity to maintain pressure within the vessel that can range from about 15 inches of mercury (about 50.8 kPa) to about 30 pounds per square inch (about 207 kPa) within the vessel. As discussed above, the split ring or locking member can move from a position of a first diameter to a reduced diameter placing it into locking position. Alternatively, the split ring or locking member can be changed from an initial diameter to an increased diameter placing the split ring or locking member in a locked position.

The locking diameter of the split ring or locking member can be changed using a screw drive or hydraulic cylinder attached to the ends of the split ring as shown in FIG. 3. The split ring has a position wherein it is not under any strain, while in its other position, it is under substantial mechanical strain due to the impact of the mechanism causing change in the diameter. It is often useful to maintain the split ring or locking member under strain for a minimum amount of time. Accordingly, the split ring is maintained in its unstressed condition while locked in place. The split ring is often under substantial strain when it is placed in an unlocked diameter during opening and closing operations of the door. The diameter of the ring can often change about 10 to 12 inches (about 25 to 30.5 cm); for example, it can be changed from 80.5 to 92.5 inches (about 2.04 to 2.35 m).

The door is typically placed on the frame structure. The door is mounted on a movable or hinge structure such that the door can be placed in a convenient closed position and an open position and rapidly moved therebetween. When in an open position, the angle at the hinge from the door structure to the line ACB passing through the center of the rotatable vessel is approximately 0 degrees. When closed, the angle between the door and hinge and line ACB is approximately 110 degrees. Typically, the hinge of the door structure is placed on the frame into which the bearing structure supporting the vessel is installed The door is placed at a position above the vessel. The term “above the vessel” in this disclosure relates to the positioning of the vessel as it is moved from its charging to its discharging position. The door is preferably placed at a location such that it will not substantially interfere in the charging and discharging of the vessel. Clearly, placing the door in a position such that the discharge from the vessel would contact the door is undesirable. Further, in charging the vessel, having the door above the charging means increases the likelihood that charging of the solid waste into the vessel will go without problem and after the charging means are removed, the door can easily be closed and locked in place. The door is moved either mechanically or using hydraulic piston and hydraulic pressure to move the door between a locked or closed position and its open position.

Once the vessel door is closed, the vessel is degassed and pressure can be introduced into the vessel. During the primary degassing, the vessel is rotated at a speed of about −8 to about 8 rpm. During this step, an eductor or other equipment draws a vacuum on the vessel to around 15 inches of mercury (about 50.8 kPa) prior to steam being introduced into the vessel. Steam used after the degassing step can remain within the vessel as moisture for further processing. The degassing process uses the eductor for degassing or gas removal. While undergoing mechanical action and shearing action, the waste material is heated to a temperature of about 200-220° F. (about 93-104° C.), generally by using around 50 pounds per square inch (about 345 kPa) of steam from the other vessel(s) that is already charged. These operations initiate the conversion of a cellulosic material into a treated material and initiate the cleaning step. During the second phase, heated liquid from the mobile fluid tends to heat the internal structure and waste material within the vessel. The vacuum drawn by the eductor on one vessel draws the steam pressure out to degas the interior of the other vessel while introducing steam and moisture into the first vessel. The end point of the degassing phase of the second vessel is detected when the pressure in the interior of the first vessel reaches or exceeds the pressure in the second vessel. At this point, the interior of the vessel is substantially filled with solid waste and moisture.

During the cooking phase, the speed of the rotation of the vessel can range from about −8 to about 8 rpm, while the direction of rotation can be alternated or maintained in a single direction to increase wetting mechanical action and shear. The angle of the vessel to the horizontal as shown in FIG. 1, angle alpha can also be adjusted to maximize wetting mechanical action and shear. Such an angle can range from approximately horizontal to as much as 20-25 degrees above or below horizontal. During the second phase, the moisture content of the material and the interior of the vessel is maintained at high proportions. The temperature and pressure within the vessel causes moisture from the steam to be absorbed by the cellulosic material aiding in the breakdown of the cellulosic material into useful fuel or fibrous end product. Within the vessel, the vessel is operated to obtain a relatively even distribution of the material within the vessel, substantial uniform moisture content of moisture within the cellulosic portion of the treated waste and to obtain constant or uniform mechanical action and shear directed to the solid waste within the vessel. One important characteristic of this step is the removal of coatings, additives, inks, sizing and other materials from the paper material into the vessel. As such, coatings, inks, clay and other coating materials are removed from the cellulosic structure.

During this phase, the temperature within the vessel is typically about 250-280° F. (about 121-138° C.) at a pressure of about 30 psi (about 207 kPa). At this moisture content, the cellulosic materials in the waste material tend to be disrupted at a maximum rate. Such disruption, as discussed above, disrupts cell structure and causes fibrous cellulosic materials to separate one from the other.

Additionally, thermoplastic materials that have a melting point less than the internal temperature of the vessel can begin to melt or deform into easily separable melt structures. These high density polyolefin and polyester products are converted into a form that are readily removed from the solid waste stream by density and particle size. Thus, the waste can be treated to separate the cellulosic fibers from the high density and low-density plastics. The low-density plastics present in the waste material often form small beads or pellets of the low-density plastics. The low density plastic can then be separated from the high-density polyester or polyolefin material. The heat treatment phase of the process can continue for a period of about 20 to about 40 minutes depending on the nature of the solid waste, the change in temperature and pressure of the materials inside and the experience with the vessel and local waste stream. During this phase, glass content of the waste can often be reduced in particle size to a glass stream that can easily be removed from the waste. Metal particulates are often unchanged by this process. Cellulosic components of the waste, however, often changed into a material that resembles cellulosic pulp or wood pulp, precursor to the papermaking process. The pulp is often separated from polymer coating, clay, filler, ink or dye constituency of the recycle waste stream material. At the end of the heat treatment, typically 20-40 minutes, the vessel is vented to the atmosphere and the interior of the vessel is heated to dry the interior components. During the drying phase, the vessel is maintained at a rotational speed of about −8 to about 8 rpm. The release in pressure and removal of moisture from the cellulosic component of the waste material tends to increase the disruption of the cellular and fibrous structure of the cellulosic material when increasing its recyclability and value. Steam is vented during the drying phase through the eductor or to another vessel to cause temperature and pressure and moisture content of the vessel to be reduced. The material cools to a temperature of 150° F. (about 65° C.) and less with a moisture content of about 40-30%. The drying of the contents can be accelerated using the introduction of heat through the heated fluid phase. As the material dries, it tends to be more easily separated into recyclable cellulosic plastic, metal and glass streams. Moisture tends to agglomerate the waste, while increased dry condition of the material tends to increase the degree of separation.

After being dried to an acceptable moisture content, typically about 30 to about 40% water, the vessel is vented through the eductor to 0 psi (0 kPa) and the door is unlocked and rotated into an open position. The vessel is then placed at an attitude where line ACB is below the horizontal position permitting ease of removal of the contents. The vessel is rotated at a rate of about −8 to about 8 rpm causing the mechanical components of the interior of the vessel to rotate and mechanically force the vessel contents to the lowered open end of the vessel. Once the angle and rotational speed of the vessel has emptied the vessel substantially, the vessel can then be raised to an attitude for further charging of waste material and further processing.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A rotatable pressure vessel having a rotational drive means and support frame, the elongated pressure vessel having an enclosed volume of about 30 to about 90 m³ capable of maintaining an internal pressure of about 10 to 4200 kPa, a relative humidity of up to about 100% relative humidity and a temperature of about 20 to 200° C., the vessel comprising a support end and a driven end, the driven end comprising means to rotate the vessel about a longitudinal axis, the support end in contact with the support frame, the interface between the support frame and the support end comprising a bearing for supporting the load of the vessel.

2. The rotatable vessel and frame of claim 1 wherein the bearing diameter is about 2.5 to about 3.5 meters and comprises steel.

3. The vessel and frame of claim 1 wherein the load comprises a thrust load that comprises about 30,000 to about 100,000 kg.

4. The vessel and frame of claim 1 wherein the load comprises an axial load that comprises about 30,000 to about 100,000 kg.

5. The vessel and frame of claim 1 wherein the vessel rotates at a rate of about −8 to about 8 rpm.

6. The rotatable vessel of claim 1 wherein the bearing comprises a bearing race affixed to the support frame and a bearing race fixed to the end, the circular bearing placed therebetween.

7. The vessel and frame of claim 6 wherein there are about 10 to about 100 spherical bearing units.

8. The vessel and frame of claim 7 wherein the bearing unit additionally comprises a seal.

9. The vessel and frame of claim 1 wherein the bearing is lubricated with a grease stable at a temperature that ranges from about 50 to about 200° C.
